(19) United States
(12) Patent Application Publication
(10) Pub. No.: US 2011/0090919 A1
(43) Pub. Date: Apr. 21, 2011

(54) ACCESS DEVICE AND METHOD FOR INITIATING V5.2 INTERFACE CONNECTION THEREOF

(75) Inventors: Yu-Ching Hsu, Tu-Cheng (TW); Wei-Wen Chuang, Tu-Cheng (TW)

(73) Assignee: HON HAI PRECISION INDUSTRY CO., LTD., Tu-Cheng (TW)

(21) Appl. No.: 12/622,701

(22) Filed: Nov. 20, 2009

(30) Foreign Application Priority Data
Oct. 20, 2009 (CN) 200910308483.0

(51) Int. Cl. H04L 12/66

(52) U.S. Cl. 370/463

(57) ABSTRACT

A method of initiating a V5.2 interface connection between an access device and a local exchange includes initiating the V5.2 interface connection, initiating a first timer, determining whether a variant and interface identifier (VID) message has been received within a first time period, and stopping the first timer when the VID message is received. The method further includes initiating a second timer, sending an unblock-all-ports (UBA) message to the local exchange, determining whether a feedback message of the UBA message is received from the local exchange, reinitiating the V5.2 interface connection if the feedback message of the UBA message is received, signifying that the V5.2 interface connection is initiated.

### BACKGROUND

1. Technical Field

Embodiments of the present disclosure relate to network communications, and more particularly to an access device and a method for initiating a V5.2 interface connection between the access device and a local exchange.

2. Description of Related Art

Open interfaces between access devices and local exchange are defined in the European Telecommunications and Standards Institute (ETSI) standard. V5.2 interfaces enable subscribers belonging to a physically separate, wired or wireless access network to be connected using a standard interface of a telephone exchange.

If the access device or the local exchange fails, a V5.2 connection therebetween needs to be reinitiated. However, since the access device and the local exchange operate at different frequencies, reinitiating synchronization may not be possible, with resumption of the V5 connection unsuccessful.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of an access device of the present disclosure; and

FIG. 2 is a flowchart of a method for initiating a V5.2 interface connection in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

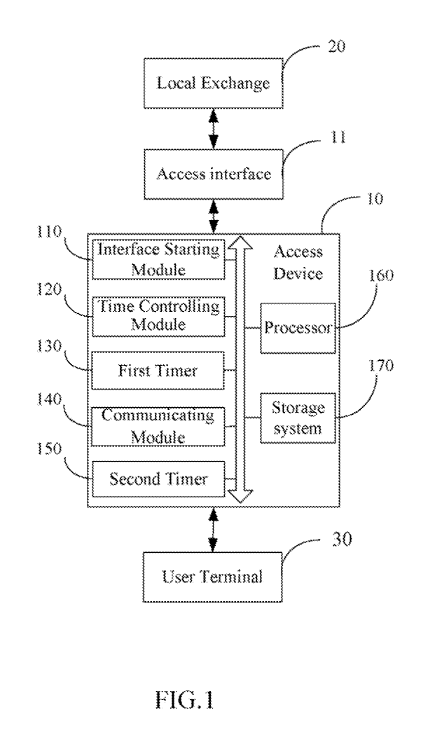

FIG. 1 is a schematic diagram of an application environment and functional modules of an access device 10 of the present disclosure. A user terminal 30 is connected to a local exchange 20 via the access device 10. The access device 10 is connected to the local exchange 20 via a V5.2 interface 11. In one embodiment, the access device 10 may be an access gateway.

The access device 10 is operable to ensure the V5.2 interface connection between the access device 10 and the local exchange 20 is successfully initiated. In one embodiment, the access device 10 includes an interface initiating module 110, a first timer 130, a communicating module 140, a second timer 150, at least one processor 160, and a storage system 170. The modules 110, 130, 140, 150 may include one or more computerized instructions stored in the storage system 170 and executed by the at least one processor 160.

The interface initiating module 110 is operable to initiate the V5.2 interface connection between the local exchange 20 and the access device 10. In one embodiment, the V5.2 interface connection may be failed for the access device 10 and the local exchange 20 operating at different frequencies.

In one embodiment, the access device 10 further includes a time controlling module 120, which is operable to initiate the first timer 130 when the V5.2 interface connection is initiated by the interface initiating module 110.

The first timer 130 is operable to time according to a first timing period when the V5.2 interface connection is initiated by the interface initiating module 110. In one embodiment, the first timing period may be predetermined, such as 190 seconds.

The communicating module 140 is operable to determine whether a variant and interface identifier (VID) message has been received within the first timing period. In one embodiment, the user terminal 30 sends the VID message to the access device 10.

The second timer 150 is operable to time according to a second timing period if the VID message is received by the communicating module 140 within the first timing period. In one embodiment, the second timing period may be predetermined, such as 30 seconds.

In one embodiment, the communicating module 140 is further operable to send an unblock-all-ports (UBA) message to the local exchange 20, and determine whether a feedback message of the UBA message has been received within the second timing period. The interface initiating module 110 is further operable to reinitiate the V5.2 interface connection when no feedback message of the UBA message is received by the communicating module 140 within the second timing period.

In one embodiment, the time controlling module 120 is further operable to determine whether the first timer 120 has timed out when no VID message is received. The interface initiating module 120 reinitiates the V5.2 interface connection when the first timer 130 times out.

In one embodiment, the time controlling module 120 is further operable to determine whether the second timer 150 has timed out no UBA message is received by the communicating module 140. The interface initiating module 110 reinitiates the V5.2 interface connection when the second timer 150 times out.

In this disclosure, the access device 10 controls the V5.2 interface connection to initiate via the first timer 130 and the second timer 150, and accordingly ensures that the V5.2 interface connection between the access device 10 and the local exchange 20 is successfully initiated.

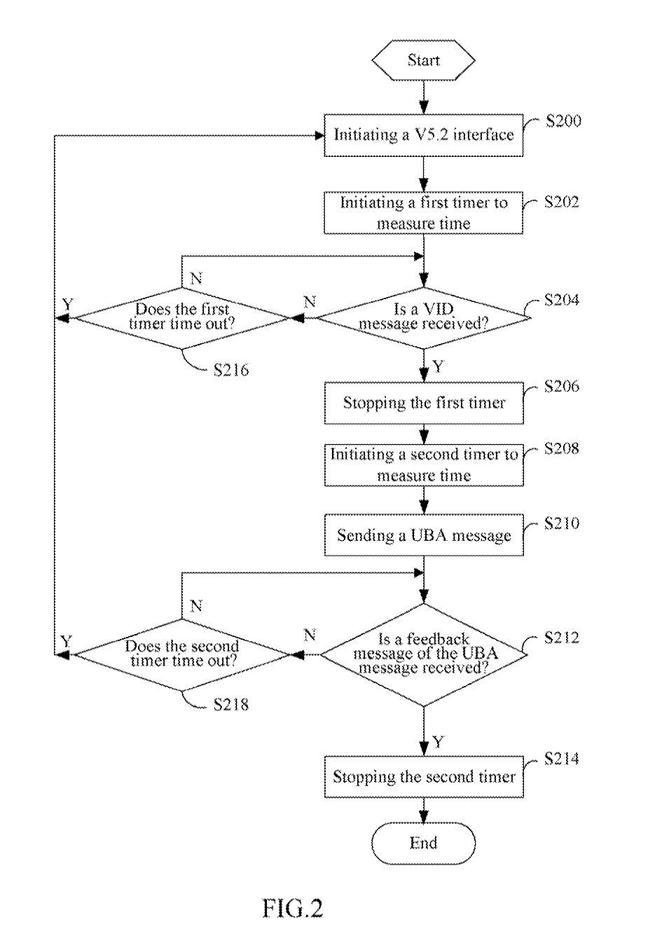

FIG. 2 is a flowchart of a method for initiating a V5.2 interface connection in accordance with the present disclosure. The method is applied in the access device 10 connected between the local exchange 20 and the user terminal 30 shown in FIG. 1, and is executed by functional modules such as those of FIG. 1. Depending on the embodiment, additional blocks may be added, others deleted, and the ordering of blocks may be changed while remaining well within the scope of the disclosure.

In block S200, the interface initiating module 110 initiates a V5.2 interface connection between the access device 10 and the local exchange 20.

In block S202, the time controlling module 120 initiates the first timer 130. In one embodiment, the first timer 130 times according to a first timing period. The first timing period may be predetermined, such as 190 seconds.

In block S204, the communicating module 140 determines whether a VID message is received. In one embodiment, the user terminal 30 sends the VID message to the access device 10 at the beginning of the first timing period.

If the communicating module 140 receives the VID message, then in block S206, the time controlling module 120 stops the first timer 130.

In block S208, the time controlling module 120 initiates the second timer 150. In one embodiment, the second timer 150 times according to a second timing period. The second timing period may be predetermined, such as 30 seconds.

In block S210, the communicating module 140 sends a UBA message to the local exchange 20 at the beginning of the second timing period. In one embodiment, the local exchange 20 returns a feedback message of the UBA message to the communication module 140. In one embodiment, the communication module 140 only sends one UBA message to the local exchange 20 within the second timing period.

In block S212, the communicating module 140 determines whether the communicating module 140 has received the feedback message of the UBA message within the second timing period.

If the communicating module 140 receives the feedback message of the UBA message, then in block S214, the time controlling module 120 stops the second timer 150. The V5.2 interface connection is successfully initiated.

In one embodiment, if the communicating module 140 does not receive the VID message within the first timing period, then in block S216, the time controlling module 120 determines whether the first timer 130 has timed out.

If not, in block S204, the communicating module 140 continues to determine whether the VID message has been received.

The V5.2 interface connection does not initiate if the first timer 130 times out, and in block S200, the interface initiating module 110 reinitiates the V5.2 interface connection.

In one embodiment, if the communicating module 140 does not receive the feedback message of the UBA message within the second timing period, then in block S218, the time controlling module 120 determines whether the second timer 150 times out.

If the second timer 150 does not time out, then in block S212, the communicating module 140 continues to determine whether the feedback message of the UBA message is received.

If the second timer 150 times out, which means that the V5.2 interface connection fails to initiate, then in block S200, the interface initiating module 110 reinitiates the V5.2 interface connection.

In this disclosure, the access device 10 controls the V5.2 interface connection to initiate via the first timer 130 and the second timer 150, and thus ensures that the V5.2 interface connection between the access device 10 and the local exchange 20 is successfully initiated.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. An access device connected to a local exchange via a V5.2 interface, the access device comprising a processor, a memory, and one or more programs, wherein the one or more programs are stored in the memory and operable to be executed by the processor, the programs comprising:
an interface initiating module operable to initiate a V5.2 interface connection between the access device and the local exchange;
a first timer operable to time according to a first timing period when the V5.2 interface connection is initiated;
a communicating module operable to determine whether a variant and interface identifier (VID) message has been received within the first timing period; and
a second timer operable to time according to a second timing period if the VID message has been received within the first timing period;
wherein the communicating module is further operable to send an unblock-all-ports (UBA) message to the local exchange when the second timer begins to time, and determine whether a feedback message corresponding to the UBA message has been received from the local exchange within the second timing period;
wherein the interface initiating module is further operable to reinitiate the V5.2 interface connection between the access device and the local exchange when no feedback message corresponding to the UBA message is received within the second timing period.

2. The access device as claimed in claim 1, further comprising a time controlling module operable to initiate the first timer.

3. The access device as claimed in claim 2, wherein the time controlling module is further operable to determine whether the first timer times out when no VID message is received.

4. The access device as claimed in claim 3, wherein the time controlling module is further operable to stop the first timer and initiate the second timer when the VID message is received.

5. The access device as claimed in claim 4, wherein the time controlling module is further operable to stop the second timer when the UBA message is received by the communicating module.

6. The access device as claimed in claim 1, wherein the access device is an access gateway.

7. A method for initiating a V5.2 interface connection between an access device and a local exchange, comprising the following computer-implemented steps:
initiating a V5.2 interface connection between the access device and the local exchange;
initiating a first timer to time according to a first timing period;
determining whether a variant and interface ID (VID) message is received within the first timing period;
stopping the first timer when the VID message is received, and initiating a second timer to time according to a second timing period;
sending an unblock-all-ports (UBA) message to the local exchange;
determining whether a feedback message of the UBA message is received from the local exchange within the second timing period; and
reinitiating the V5.2 interface if the feedback message of the UBA message is received from the local exchange within the second timing period.

8. The method as claimed in claim 7, further comprising the following computer-implemented steps:
determining whether the first timer times out if no VID message is received; and
reinitiating the V5.2 interface connection if no VID message is received within the first timing period.

9. The method as claimed in claim 7, further comprising the following computer implemented steps:
stopping the second timer when the feedback message of the UBA message is received from the local exchange within the second period, whereby the V5.2 interface connection is successfully initiated.
